(19) United States
(12) Patent Application Publication
(10) Pub. No.: US 2008/0196454 A1
(43) Pub. Date: Aug. 21, 2008

(54) Universal lock Assembly

(76) Inventor: Donald R. Frantz, New Berlin, WI (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(21) Appl. No.: 11/917,735

(22) PCT Filed: Jun. 15, 2005
(86) PCT No.: PCT/US05/21135

§ 371 Date: Dec. 17, 2007

(51) Int. Cl. E05B 67/36

(52) U.S. Cl. 70/14

(57) ABSTRACT

A universal lock assembly (10) has a linearly-extending member (20) having a first end with a stop member (22). Extending linearly and away from the stop member (22) is a shaft member (24) having a continuous plurality of circumferential ridge (28) and indentations (27) defined within it. The indentations (27) are generally arcuate and the ridges (28) are formed from the peaks that are disposed between adjacent arcuate indentations (27). Given the circumferential nature of the ridge (28) and the indentations (27), the linearly-extending member (20) can be positioned in any position relative to a 360° radial axis. A lock sub-assembly (30) is provided which has an aperture (37) for receiving the shaft (24) of the linearly-extending member (20). Disposed within the lock sub-assembly (30) is a positioning means (36), which positioning means (36) properly positions the lock mechanism (34, 42) within the lock sub-assembly (30) with one of the indentations (27) along the shaft (24) of the linearly-extending member (20) which insures proper seating of the lock mechanism (34, 42).

### FIELD OF THE INVENTION

The present invention relates generally to locks and to other security devices that use locks and locking mechanisms. More specifically, it relates to an assembly that is used to secure any number of items together where the items provide a lock-receiving aperture but are differently sized or dimensioned.

### BACKGROUND OF THE INVENTION

There are many items that require a lock to be placed on them to prevent removal of the item from another item or to prevent unwanted separation of the items. One such application is in the area of hitches of the type that are used to attach a trailer to a motor vehicle by use of a ball and hitch combination. In this application, the ball is typically secured to the back end of a motor vehicle. The forward-most portion of the trailer includes a hitch that fits onto the ball. The hitch also includes a lever that can be used to secure the hitch onto the ball. To prevent unintended detachment of the trailer from the motor vehicle that is towing it, the hitch is provided with a generally horizontally-disposed aperture that keeps the lever in its locking position. Without such a lock in place, the trailer could be detached from the motor vehicle and removed by someone other than the owner. Also, when the vehicle is in motion, vibration through the trailer and hitch could result in an inadvertent disengagement between the motor vehicle and the trailer such that the trailer becomes an instrument for causing an accident on the highway. In either situation, it is clearly desirable to keep the trailer and the motor vehicle secured together.

Typical of the various types of locks that are available for such purpose are locks having a linearly-extending member with some sort of lock mechanism disposed on one or both ends of the linearly-extending member, such member being receivable within the hitch aperture as described above. There are also many different hitches that are on the market for such use, each such hitch being differently dimensioned from the other. Thus, there is a requirement that differently dimensioned lock assemblies be used to lock the various types and sizes of hitches that are available.

### SUMMARY OF THE INVENTION

In the view of this inventor, what is needed is a universal-type lock assembly that could be used to provide incremental movement of a lock sub-assembly along a linearly-extending member. In this fashion, the lock assembly could be used to lock different items of different sizes and dimensions, including trailer hitches as previously described, cargo doors, and many other devices, the lock assembly being extremely versatile in its use. What is also needed is a lock assembly of this type that is easy to use, and which is simple in its construction.

The present invention provides such an assembly. The present invention provides for a universal lock assembly having a linearly-extending member having a first end with a stop member formed in it. Extending linearly and away from the stop member is a shaft member having a continuous plurality of circumferential ridges and indentations defined within it. The indentations are generally arcuate and the ridges are formed from the peaks that are disposed between adjacent arcuate indentations. Given the circumferential nature of the ridges and the indentations, the linearly-extending member can be positioned in any position relative to a 360° radial axis. A lock sub-assembly is provided which has an aperture for receiving the shaft of the linearly-extending member. Disposed within the lock sub-assembly is a positioning means, which positioning means properly positions the lock mechanism within the lock sub-assembly with one of the indentations along the shaft of the linearly-extending member. This feature insures proper seating of the lock mechanism. Given the continuous plurality of the circumferential ridges and indentations, the lock mechanism can be secured to the linearly-extending member in any number of positions.

The foregoing and other features of the assembly of the present invention will be apparent from the detailed description that follows.

### BRIEF DESCRIPTION OF THE DRAWINGS

FIG. 1 is a front, bottom and right side perspective view of the universal lock assembly of the present invention showing the lock sub-assembly attached to the linearly-extending member.

FIG. 2 is a front elevational view of the universal lock assembly of the present invention showing the lock sub-assembly detached from the linearly-extending member and showing the lock sub-assembly in exploded view.

FIG. 3 is an enlarged top plan and cross-sectioned view of a portion of the universal lock assembly taken along line 3-3 of FIG. 1 and showing the lock properly engaged.

FIG. 4 is the same view as illustrated in FIG. 3 and showing how the lock cannot be properly engaged without proper positioning of the seating means within the lock sub-assembly.

FIG. 5 is an enlarged front elevational view of the linearly-extending member without the lock subassembly attached to it.

FIG. 6 is an enlarged front elevational and cross-sectioned view of a portion of the universal lock assembly taken along line 6-6 of FIG. 1 and showing the lock properly engaged.

### DETAILED DESCRIPTION OF THE INVENTION

Referring now to the drawings in detail, wherein like numbered elements correspond to like elements throughout, FIG. 1 is a perspective view showing a preferred embodiment of the universal lock assembly, generally identified 10, that is constructed in accordance with the present invention. As shown, the lock assembly 10 includes a linearly-extending member 20 and a lock sub-assembly 30.

Preferably, the linearly-extending member 20 is a one-piece unitary and shaft-like structure that is generally round in its diametrical dimension and is axially symmetrical. That is, viewed from any position of axial rotation, the member 20 is uniformly symmetrical, and intentionally so. The linearly-extending member 20 includes a stop member, or head, 22 formed at one end. Extending linearly and away from the stop member 22 is a shaft 24. The diameter of the stop member 22 is larger than that of the shaft 24 due to its intended function which is to prevent that end of the member 20 from passing through an aperture (not shown) that the universal lock assembly might be used with. Although formed as a single structure in the preferred embodiment, the stop member 22 and the shaft 24 could be formed separately and then attached together, but such is not preferred in this embodiment. The shaft 24 has, at first, a smooth shaft portion 23 immediately adjacent the stop member 22 and then a grooved portion 26. The presence of the smooth shaft portion 23 is that portion along which the lock sub-assembly 30 would not be attachable to, but such is not a limitation of the present invention.

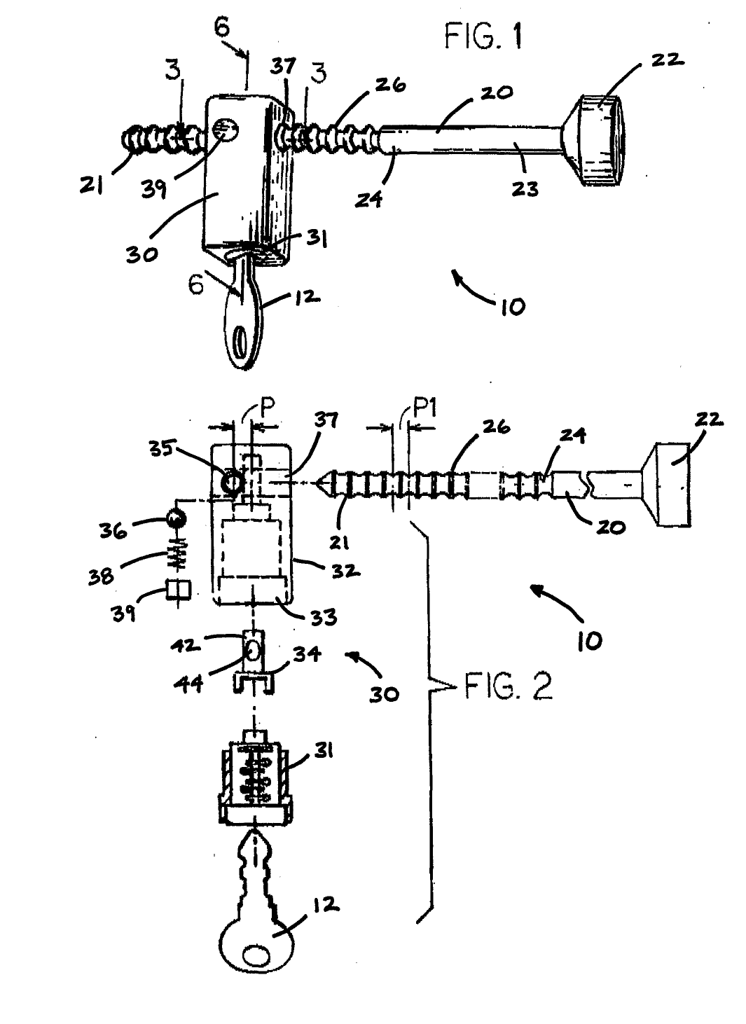

The grooved portion 26 of the shaft 24 includes a series of adjacent, and alternating, circumferential grooves 27 and ridges 28 defined within it. The grooves 27 are generally arculate and the ridges 28 are formed from the peaks that are disposed between the adjacent arcuate grooves 27. As shown in FIG. 5, alternating grooves 27a, 27b and ridges 28a, 28b are identically configured. Given the circumferential nature of the ridges 28 and the grooves 27, the linearly-extending member 20 can be positioned in any position relative to a 360° radial axis. It is also to be noted that the pitch P1 between the bottom-most portion of any two adjacent grooves 27, 27a, or between any two adjacent ridges 28, 28a, is uniform along the shaft 24. The radius of each groove 27 corresponds roughly with the radius of the ball 36 that is identified in FIG. 2. The purpose of this correlation will be apparent later in this detailed description.

A lock sub-assembly 30 is also provided as part of the universal lock assembly 10 and includes a lock housing 32. The lock housing 32 is a somewhat box-like structure that has a shaft-receiving aperture 37 which is functionally adapted for receiving the shaft end 21 of the linearly-extending member 20. Disposed within the lock housing 32 is a positioning means 36, which positioning means 36 is provided to properly position a latch 34 within the lock sub-assembly 30 with one of the grooves 27a along the shaft 24 of the linearly-extending member 20. See FIG. 2. This feature insures proper seating of the lock mechanism.

Referring to FIG. 2 in greater detail, it will be seen that the lock housing 32 includes the shaft-receiving aperture 37 as previously mentioned, and it also includes a lock cylinder-receiving aperture 33 and a locating aperture 35. Note that, in the preferred embodiment, the three apertures 33, 35, 37 are arranged in an x, y, z axis configuration for maximizing the space within the housing 32. Such is not, however, a limitation of the present invention. In fact, this inventor has configured the apertures 33, 35, 37 using alternative configurations which work as well as the preferred embodiment, but require different positioning for placement of the apertures 33, 35, 37 within the housing 32. It should also be noted that, in the preferred embodiment, the pitch P between the axis of the lock cylinder-receiving aperture 33 and the axis of the locating aperture 35 is the same as the pitch P1 between adjacent grooves 27, 27a and ridges 28, 28a. The purpose of this configuration will be apparent later in this detailed description as well.

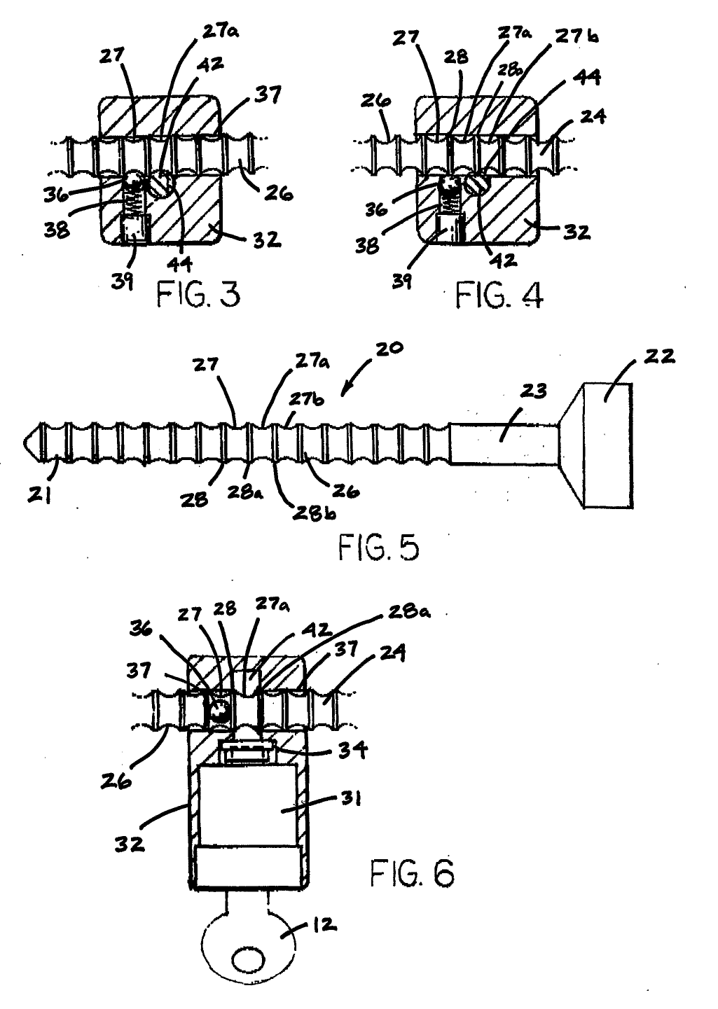

In the preferred embodiment, the locating aperture 35 is functionally adapted to intersect the shaft-receiving aperture 37. The locating aperture 35 is also functionally adapted to receive a ball 36, a spring 38 and a plug 39, in that order. In this configuration, the spring 38 is interposed between the ball 36 and the plug 39, such that the ball 36 is spring-biased against a portion of the shaft 24 when the shaft 24 is situated within the shaft-receiving aperture 37. See, for example, FIGS. 3 and 4. The innermost end of the locating aperture 36 can be of a smaller diameter than that of the remainder of the locating aperture 36 to insure that the ball 36 does not exit the locating aperture 36 when the shaft 24 is fully withdrawn from the shaft-receiving aperture 37.

In the preferred embodiment, the lock cylinder-receiving aperture 33 is also functionally adapted to intersect the shaft-receiving aperture 37. In this fashion, the latch 34 extends inwardly of the shaft-receiving aperture 37 to engage a portion of the shaft 24 when the shaft 24 is situated within the shaft-receiving aperture 37. The latch 34 is also actuated by a lock cylinder 31 that is placed within the lock cylinder-receiving aperture 33. As shown in FIGS. 2, 3 and 4, the latch 34 includes a latch pin 42 having flat 44. When the latch pin 42 is rotated in a first position, as shown in FIG. 4, the shaft 24 is not engaged by the latch pin 42, but instead passes by the latch pin flat 44. When the latch pin 42 is rotated to a second position, as shown in FIG. 3, the shaft 24 is engaged with the pin 42, thus resulting in the shaft 42 being locked in placed at a given longitudinal point. The actuation of the latch pin 42 between these two positions is provided by means of the lock cylinder 31 which is actuated by means of a key 12. See FIGS. 2 and 6, in particular.

Given the continuous plurality of the circumferential ridges 28 and grooves 27 within the shaft 24 of the linearly-extending member 20, the lock sub-assembly 30 can be secured to the linearly-extending member 20 in any number of positions. Additionally, the presence of the locating ball 36, together with the fact that the pitch P between the axis of the lock cylinder-receiving aperture 33 and the axis of the locating aperture 35 is the same as the pitch P1 between adjacent grooves 27, 27a and ridges 28, 28a, insures that the latch pin 42 will always be properly seated. Thus, the spacing between the lock cylinder-receiving aperture 33 and the locating aperture 35 is, in the preferred embodiment, such that the ball 36 within the locating aperture 35 will seek to be urged into the arcuate-shaped groove 27 of the shaft 24. When this occurs, then the latch pin 42 will be properly positioned and may be used within an adjacent groove 27a to seat the latch pin 42 within the groove 27a.

In application, and assuming that the linearly-extending member 20 and the lock sub-assembly 30 of the universal lock assembly 10 are in an initial detached position, the user first inserts the shaft end 21 of the linearly-extending member 20 through the object or objects to be locked and into the shaft-receiving aperture 37 of the housing 32. Such objects could include trailer hitches, cargo doors, and other devices. As the shaft 24 is urged into the shaft-receiving aperture 37, the series of ridges 28 and grooves 27 will cause “in-and-out” movement of the ball 36. At the desired point of engagement of the housing 32 relative to the shaft 24, the ball 36 will properly seat within a given groove 27. See FIG. 3. In this position, the key 12 can be turned to actuate the lock cylinder 31 which, in turn, actuates the latch 34 and the latch pin 42. The latch pin 42 is then seated into an adjacent groove 27a and the object is now locked. Removal of the shaft 24 from the lock sub-assembly 30 is thus prevented because the ridges 28, 28a are to either side of the latch pin 42 to prevent longitudinal movement of the shaft 24. The head 22 of the linearly-extending member 20 also serves to prevent longitudinal movement of the shaft 24 with the housing 32 attached to it. In order to remove the lock sub-assembly 30 from the linearly-extending member 20, the reverse of the foregoing steps are required.

Additional advantages and modifications will readily occur to those skilled in the art. Therefore, the invention in its broader aspects is not limited to the specific details disclosed and described herein. Accordingly, various modifications may be made without departing from the spirit or scope of the general inventive concept.

What is claimed is:

1. A lock assembly (10) that comprises:
a linearly-extending member (20), said linearly-extending member (20) having a stop member (22) and a shaft portion (24), the shaft portion (24) including a plurality of alternating grooves (27) and ridges (28) circumferentially defined within an adjacently disposed along the shaft portion (24), and
a lock sub-assembly (30), the lock sub-assembly (30) including a shaft-receiving aperture (37) for receiving the shaft portion (24) of the linearly-extending member (20) therethrough and including a lock means (31, 34) that is engageable with at least one of the grooves (27) defined within the shaft portion (24).

2. The lock assembly (10) of claim 2 wherein each of the grooves (28) defined within the linearly-extending member (20) is circular in axial cross-section and generally arcuate in longitudinal cross-section.

3. The lock assembly (10) of claim 3 wherein the lock sub-assembly (30) includes a positioning means (36) that is engageable with at least one of the grooves (27) defined within the shaft portion (24).

4. The lock assembly (10) of claim 4 wherein the lock means (31, 34) includes a latch pin (42) having a flat (44) wherein the flat (44) allows the ridges (38) of the shaft (24) to pass by it during insertion of the shaft (24) when the latch pin (42) is in a first position and wherein the latch pin (42) engages a groove (27) when the latch pin (42) is in a second position.

5. The lock assembly (10) of claim 1 wherein the linearly-extending member (20) is unitary in construction.

6. A lock assembly (10) that comprises:
a linearly-extending member (20),
and a lock sub-assembly (30),
wherein the linearly-extending member (20) is a shaft-like structure that is generally round in its axial cross-section and includes a stop member (22) and a shaft (24), the diameter of the stop member (22) being larger than that of the shaft (24), and the shaft (24) having a longitudinally-extending grooved portion (26), the grooved portion (26) including a plurality of adjacent, and alternating, circumferential grooves (27) and ridges (28) defined within it, the grooves (27) being generally arcuate longitudinally and the ridges (28) being formed from the peaks that are disposed between adjacent arcuate grooves (27).

7. The lock assembly (10) of claim 6 wherein the lock sub-assembly (30) includes a lock housing (32), the lock housing (32) having a shaft-receiving aperture (37) that is functionally adapted for receiving the shaft end (21) of the linearly-extending member (20) and further includes a positioning means (36), which positioning means (36) is provided to properly position a latch (34) within the lock sub-assembly (30) with one of the grooves (27) along the shaft (24) of the linearly-extending member (20).

8. The lock assembly (10) of claim 7 wherein the lock housing (32) includes a lock cylinder-receiving aperture (33) and a locating aperture (36), the locating aperture (36) intersecting the shaft-receiving aperture (37).

9. The lock assembly (10) of claim 8 wherein the locating aperture (36) is configured to receive a ball (36), a spring (38) and a plug (39) such that the spring (38) is interposed between the ball (36) and the plug (39), and the ball (36) being spring-biased against a portion of the shaft (24) when the shaft (24) is situated within the shaft-receiving aperture (37).

10. The lock assembly (10) of claim 9 wherein the lock cylinder-receiving aperture (33) is configured to intersect the shaft-receiving aperture (37) such that the latch (34) extends inwardly of the shaft-receiving aperture (37) to engage a portion of the shaft (24) when the shaft (24) is situated within the shaft-receiving aperture (37).

11. The lock assembly (10) of claim 9 wherein the latch (34) includes a latch pin (42) having flat (44) such that, when the latch pin (42) is rotated in a first position, the shaft (24) is not engaged by the latch pin (42), the shaft (24) being passable by the latch pin flat (44) and such that, when the latch pin (42) is rotated to a second position, the shaft (24) is engaged with the pin (42) which locks the shaft (42) in placed at a given longitudinal point along the lock sub-assembly (30).

12. The lock assembly (10) of claim 11 wherein the actuation of the latch pin (42) between the two positions is provided by a lock cylinder (31) disposed within the lock cylinder-receiving aperture (33), the lock cylinder (31) being actuated by means of a key (12).
